(19) United States
(12) Patent Application Publication
(10) Pub. No.: US 2017/0112346 A1
(43) Pub. Date: Apr. 27, 2017

(54) SPONGE-BASED CLEANING DEVICE WITH SELF-CONTAINED DETERGENT RESERVOIR

(71) Applicant: Jiaxing Tian, Sunnyvale, CA (US)

(72) Inventor: Jiaxing Tian, Sunnyvale, CA (US)

(21) Appl. No.: 14/922,414

(22) Filed: Oct. 26, 2015

(51) Int. Cl. A47L 13/17; A47K 7/03; B05C 17/005

(52) U.S. Cl. CPC A47L 13/17; B05C 17/005; A47K 7/03

(57) ABSTRACT

The system herein disclosed and claimed is a sponge-based cleaning device with self-contained detergent reservoir.

### TECHNICAL FIELD

This invention is associated with sponge-based cleaning devices.

### BACKGROUND OF THE INVENTION

Sponge-based cleaning devices are used for general purpose cleaning where water and a soap or detergent are used in conjunction with the sponge. Such cleaning devices are used to clean dishes, automobiles, for personal hygiene, and the like.

There are a variety of devices that incorporate detergent reservoirs in the form of extended handles that can filled with liquid detergent, and plastic reservoirs that serve as hand holds and are external to the sponge.

These plastic handles and hand holds add significantly to the cost of a cleaning device, and they significantly increase the size and weight of the cleaning device.

### BRIEF SUMMARY OF THE INVENTION

The invention herein disclosed and claimed is a sponge-based cleaning device that contains the detergent reservoir inside rather than external to the sponge.

Detergent is inserted into the reservoir via a filling aperture on an outside surface of the sponge. The surface mounted aperture is operative to allow detergent to be inserted into the reservoir but prevents detergent from exiting the filling aperture. Instead, when the sponge is wetted, and the sponge is compressed, the detergent in the reservoir will exit into the sponge material.

When all the detergent initially filling the reservoir has been used up, additional detergent can be added via the filling aperture.

The reservoir takes advantage of the sponge material itself to form its enclosure requiring no additional handle or hand hold structures.

Optionally, one could insert a perforated bladder-like structure into the reservoir that acts as the enclosure and does not rely on the sponge material to form the enclosure.

### BRIEF DESCRIPTIONS OF THE DRAWINGS

FIG. 1 depicts a side view of the sponge-based cleaning device showing a cylindrical shaped reservoir formed in the sponge's interior.

FIG. 2 is a top or bottom view of the sponge-based cleaning device showing the reservoir, and a cavity interface connecting the reservoir to the outside sponge surface.

FIG. 3 is a side view normal to the side view of FIG. 1 showing the reservoir and its interface to an outside surface

FIG. 4 shows a filling aperture substructure that is affixed to the side of the sponge coincident with the interface cavity.

FIG. 5 shows a side view of a bladder-like insert that can be placed in the reservoir and interface cavity.

FIG. 6 shows a top view of the bladder-like insert

FIG. 7 shows a side view of the bladder-like insert normal to that of FIG. 5.

### DETAILED DESCRIPTION OF THE INVENTION

Sponge-based cleaning devices are used copiously for cleaning dishes, automobiles, for personal hygiene, and the like. It is common to use them in conjunction with soap or detergent plus water. Such devices have been introduced that use an attached hollow plastic handle as a liquid soap or detergent reservoir. Others have used plastic hand holds attached to the sponge for the same purpose. In both cases, the handle or hand hold adds size, weight and cost to the end device.

The invention herein disclosed and claimed provides the same convenience of self-contained detergents but uses a reservoir in the interior of the sponge rather than an appendage. As a result, size and shape are unaffected, and costs of production may be lower.

The invention does not depend upon the size or shape of the base sponge structure. Essentially a reservoir is created within the sponge's interior into which liquid detergent will be inserted. This reservoir cavity can be any shape, such as cylindrical, cubic, or spherical. An interface cavity connects the reservoir cavity to the outside surface of the sponge. The interface cavity can be considered a pipe through which the liquid detergent passes from the outside to the reservoir cavity. The interface cavity can also be cylindrical, like a pipe, or rectangular girder-like in shape.

Affixed to the outside sponge surface and extending into the interface cavity is a filling aperture substructure. A nozzle that fits into the aperture, such as the exit tube of a sub-sink detergent dispenser, can be inserted into the aperture and pumped to fill the reservoir cavity with detergent. Detergent bottles can also be outfitted with a filling cap that does essentially the same thing.

Once the reservoir is filled, and the nozzle removed, the filling aperture substructure has an integral one-way valve substructure that prevents liquid from exiting the aperture.

In one embodiment of the invention, the interior surfaces of the sponge material provide the enclosure surrounding the reservoir cavity. Similarly, the interior surfaces of the sponge material provide the encasing sides of the interface cavity.

The nature of the one-way action of the filling aperture and sponge-like material of the cleaning device serve to keep the liquid detergent confined to the reservoir until the sponge is wetted and compressed.

Another embodiment of the invention makes use of a perforated bladder having the same size and shape as the reservoir and interface cavities and which essentially forms the enclosure and encasing of both. The choice of location of the perforations can predetermine the flow paths that the detergent will follow when the sponge is wetted and compressed.

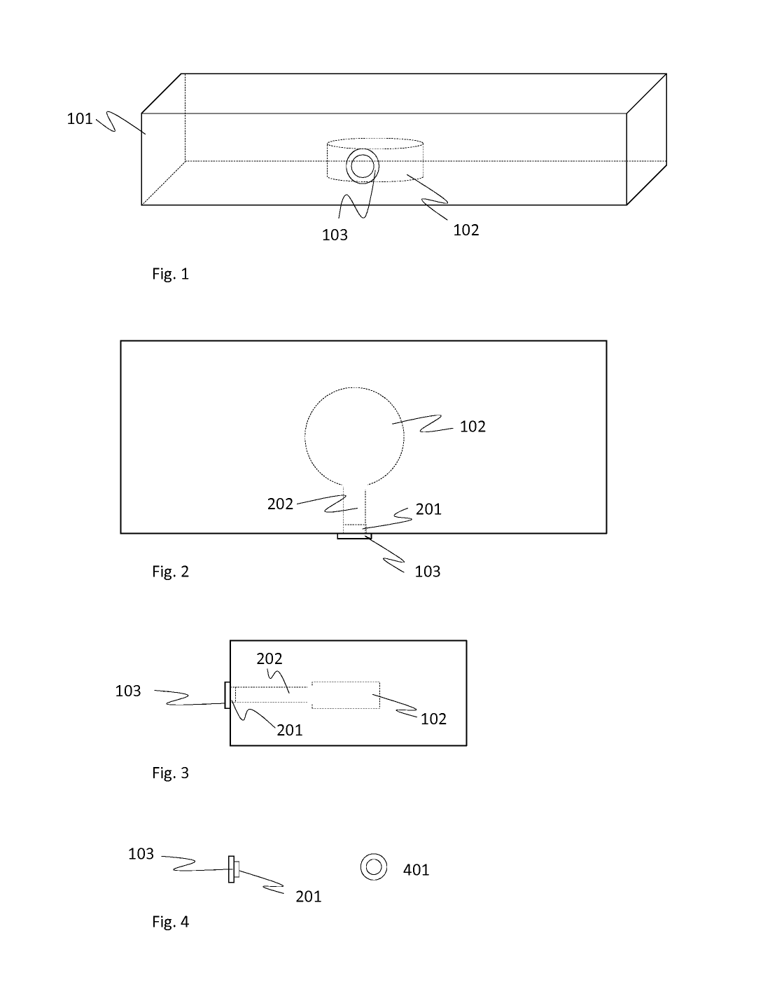

FIG. 1 is a side view of one embodiment of the invention showing the base sponge structure 101, the reservoir cavity 102 and the filling aperture 103.

FIG. 2 is a top or bottom view of the embodiment of FIG. 1 showing the reservoir cavity 102, interface cavity 202, one-way valve substructure 201 and the filling aperture 103.

FIG. 3 is a side view perpendicular to that of FIG. 1 showing the reservoir cavity 102, interface cavity 202, one-way valve 201 and filling aperture 103.

FIG. 4 shows more detail of the filling aperture 103 and one-way value 201. A front view 401 is also shown.

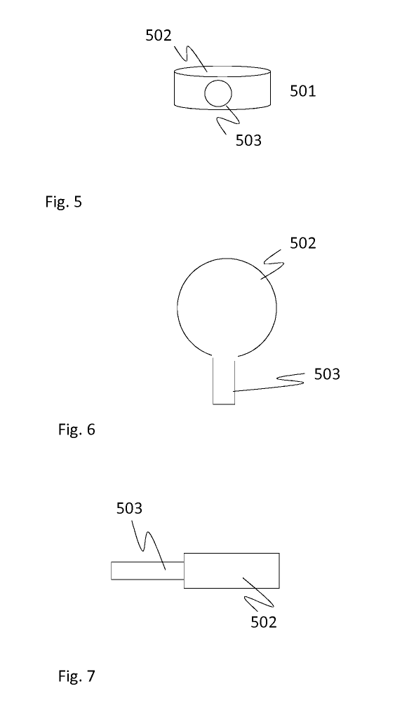

FIG. 5 illustrates the perforated bladder-like insert 501 that is the same size and shape as the reservoir cavity 502 and interface cavity 503.

FIG. 6 is a top or bottom view of same showing the bladder structure's reservoir cavity 502 and interface cavity 503.

FIG. 7 is a side view perpendicular to the view of FIG. 5 showing the bladder structure's reservoir cavity 502 and interface cavity 503.

The two embodiments are meant to be exemplary and should not be read as limiting the scope of the claimed invention. The cylindrical shape of the reservoir cavity and interface cavity are one of many possible shapes. The rectangular shape of the base sponge structure is also exemplary. The sponge could be cylindrical in shape, or, for that matter, any three dimensional geometric shape. The sponge material can be any such material. Celluloid is the most common material for such cleaning devices. The filling aperture and one-way valve can be made of any rigid material such as hard plastic or metal.

What is claimed is:

1. A system comprising:
A base structure comprising sponge-like material;
A reservoir cavity located at essentially the center of said base structure;
An interface cavity extending from an outside surface of said base structure to said reservoir cavity;
A filling aperture substructure located on said outside surface of said base structure and extending into said interface cavity forming a snug fit;
A one-way valve substructure, integral to said filling aperture substructure, and operative to allow liquid to flow only from said aperture substructure to said interface cavity and, thereby, said reservoir cavity.

2. A system as in claim 1 further comprising:
A perforated bladder structure whose dimensions are essentially the same as said reservoir cavity and said interface cavity;
Said perforated bladder substructure having a plurality of perforations on its surfaces operative to allow liquid inside said perforated bladder substructure to exit via said perforations.

3. A system as in claim 1 further comprising:
Said reservoir cavity is cylindrical in shape;
Said interface cavity is cylindrical in shape.

4. A system as in claim 2 further comprising:
Said reservoir cavity is cylindrical in shape;
Said interface cavity is cylindrical in shape.
